(19) United States
(12) Patent Application Publication
(10) Pub. No.: US 2023/0013385 A1
(43) Pub. Date: Jan. 19, 2023

(54) LEARNING APPARATUS, ESTIMATION APPARATUS, METHODS AND PROGRAMS FOR THE SAME

(71) Applicant: NIPPON TELEGRAPH AND TELEPHONE CORPORATION, Tokyo (JP)

(72) Inventors: Yuki KITAGISHI, Tokyo (JP); Takeshi MORI, Tokyo (JP); Hosana KAMIYAMA, Tokyo (JP); Atsushi ANDO, Tokyo (JP); Satoshi KOBASHIKAWA, Tokyo (JP)

(73) Assignee: NIPPON TELEGRAPH AND TELEPHONE CORPORATION, Tokyo (JP)

(21) Appl. No.: 17/783,245

(22) PCT Filed: Dec. 9, 2019
(86) PCT No.: PCT/JP2019/048049

§ 371 Date: Jun. 7, 2022

(51) Int. Cl. G10L 17/04; G10L 17/02; G10L 17/18; G10L 25/51

(52) U.S. Cl. CPC G10L 17/04; G10L 17/02; G10L 17/18; G10L 25/51

(57) ABSTRACT

A learning apparatus includes: a speaker vector learning unit configured to learn a speaker vector extraction parameter λ based on one or more items of learning speech voice data in a speaker vector voice database; a non-speaker-individuality sound model learning unit configured to create a probability distribution model using a frequency component of one or more items of non-speaker-individuality sound data in a non-speaker-individuality sound database and calculate an internal parameter of the probability distribution model; and an age level estimation model learning unit configured to extract a speaker vector from voice data in an age level estimation model-learning voice database using the speaker vector extraction parameter λ, calculate a non-speaker-individuality sound likelihood vector from voice data in the age level estimation model-learning voice database using the internal parameters μ and Σ, and learn, with input of the speaker vector and the non-speaker-individuality sound likelihood vector, a parameter Ω of an age level estimation model that outputs an estimated value of an age level of a corresponding speaker.

### TECHNICAL FIELD

The present invention relates to an estimation apparatus that estimates the age level of a speaker from voice data, a learning apparatus for an estimation model used in the estimation apparatus, an estimation method, a learning method, and a program.

### BACKGROUND ART

There is a need for a technique for automatically estimating, from human voice, the age level of a person (speaker) who has spoken. For example, in the case of automated answering in a contact center, if it can be estimated that a caller is an elderly person, the caller can respond appropriately such as (1) reproducing an answering voice easy for elderly people to hear or (2) making a person respond directly to the elderly person who is poor at operating buttons by following voice guidance. In a dialogue with an agent or a robot, if the speaker is an elderly person, it is conceivable to switch to response suitable for the elderly person, such as speaking slowly.

Conventionally, feature vectors such as an i-vector and an x-vector that represent speaker individuality have been used as feature values to estimate speaker ages (see Non-Patent Literature 1). Note that the speaker individuality means individuality of a person in speaking. Hereinafter, the feature vector that represents speaker individuality will also be referred to as a speaker vector. The speaker vector has been proposed as a feature value for use to estimate who has spoken (speaker detection), whether a registered speaker has spoken (speaker verification), and the like. Actually, however, the speaker vector is used not only for speaker detection and speaker verification, but also for a technique for carrying out machine learning by replacing an individual (speaker) with age and sex in data corresponding to the speaker vector and thereby estimating age and sex of a speaker (see Non-Patent Literatures 2 and 3).

### CITATION LIST

### Non-Patent Literature

Non-Patent Literature 1: David Snyder et al., “X-Vectors: Robust DNN Embeddings for Speaker Recognition”, 2018 IEEE International Conference on Acoustics, Speech and Signal Processing (ICASSP)

Non-Patent Literature 2: Joanna Grzybowska et al., “Speaker Age Classification and Regression Using i-Vectors”, INTERSPEECH 2016

Non-Patent Literature 3: Pegah Ghahremani et al., “End-to-end Deep Neural Network Age Estimation”, INTERSPEECH 2018 pp.277-pp.281

### SUMMARY OF THE INVENTION

### Technical Problem

However, the speaker vector, which is a feature vector used to represent only speaker individuality, is not necessarily suitable for representing a non-speaker-individuality sound, i.e., an acoustic feature irrelevant to speaker individuality. Note that the non-speaker-individuality sound is a sound irrelevant to speaker individuality and may be or may not be produced in speaking by a speaker at a certain age level.

Examples of non-speaker-individuality sounds will be described. When attention is focused on elderly people, elderly people are liable to accumulation of saliva in the oral cavity due to decline in ability to swallow, and highly viscous saliva accumulates in the oral cavity along with evaporation of saliva. In this state, if a person makes such a sound with consonants “t” or “n” by causing the tongue to touch the palate during pronunciation, the highly viscous saliva produces a sticky water sound. The water sound is a non-speaker-individuality sound. The water sound is not always produced when an elderly person pronounces a sound by causing the tongue to touch the palate, and is produced or not produced on a case by case basis depending on the situation in the oral cavity. Note that the situation in the oral cavity varies, for example, with various factors including the amount and viscosity of saliva in the oral cavity, which vary with the amount of saliva secretion and continuous speech duration. On the other hand, adults other than elderly people, who have sufficient ability to swallow, can swallow saliva appropriately, and produce such water sounds less frequently than elderly people. Thus, if the occurrence frequency of the water sounds can be grasped, the age levels can be estimated accurately for elderly people.

That is, in order to estimate the age level of a speaker with higher accuracy, as described above, it is necessary to grasp not only a speaker vector, but also non-speaker-individuality sounds that are prone to occur during speaking by speakers at a specific age level and that cannot be represented by speaker vectors.

An object of the present invention is to provide an estimation apparatus that estimates the age level of a speaker with higher accuracy by taking non-speaker-individuality sounds into consideration, a learning apparatus for an estimation model used in the estimation apparatus, an estimation method, a learning method, and a program.

### Means for Solving the Problem

To solve the above problem, according to one aspect of the present invention, there is provided a learning apparatus including: a speaker vector learning unit configured to learn a speaker vector extraction parameter X based on one or more items of learning speech voice data in a speaker vector voice database; a non-speaker-individuality sound model learning unit configured to create a probability distribution model using a frequency component of one or more items of non-speaker-individuality sound data in a non-speaker-individuality sound database and calculate an internal parameter of the probability distribution model; and an age level estimation model learning unit configured to extract a speaker vector from voice data in an age level estimation model-learning voice database using the speaker vector extraction parameter λ, calculate a non-speaker-individuality sound likelihood vector from voice data in the age level estimation model-learning voice database using the internal parameters μ and Σ, and learn, with input of a speaker vector and a non-speaker-individuality sound likelihood vector, a parameter Ω of an age level estimation model that outputs an estimated value of an age level of a corresponding speaker.

### Effects of the Invention

The present invention offers the effect of being able to estimate speaker ages with higher accuracy than conventional age level estimation techniques that are based solely on speaker vectors.

### BRIEF DESCRIPTION OF DRAWINGS

FIG. 1 is a functional block diagram of an estimation system according to a first embodiment.

FIG. 2 is a functional block diagram of a learning apparatus according to the first embodiment.

FIG. 3 is a diagram showing an exemplary process flow of the learning apparatus according to the first embodiment.

FIG. 4 is a functional block diagram of an estimation apparatus according to the first embodiment.

FIG. 5 is a diagram showing an exemplary process flow of the estimation apparatus according to the first embodiment.

FIG. 6 is a diagram showing an example of a speaker vector voice DB.

FIG. 7 is a diagram showing an example of a non-speaker-individuality sound DB.

FIG. 8 is a diagram showing an example of an age level estimation model learning DB.

FIG. 9 is a diagram showing a configuration example of a computer to which the present technique is applied.

### DESCRIPTION OF EMBODIMENTS

An embodiment of the present invention will be described below. Note that in the drawings used in the following description, components having the same functions or steps that perform the same processes are denoted by the same reference numerals as the corresponding components or processes, and redundant description thereof will be omitted. In the following description, processes performed for each individual element of a vector or a matrix are applied to all the elements of the vector or the matrix unless otherwise noted.

### Point of First Embodiment

A point of a first embodiment is to implement more accurate estimation of age levels of speakers by catching non-speaker-individuality sounds that occur characteristically of a certain age group during speaking and that are not completely catchable by conventional age level estimation techniques, which are based on speaker vectors, and using the non-speaker-individuality sounds jointly with speaker vectors.

### First Embodiment

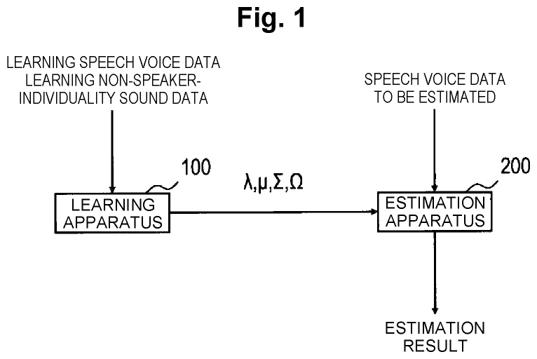

FIG. 1 shows a configuration example of an estimation system according to the first embodiment.

The estimation system includes a learning apparatus 100 and an estimation apparatus 200.

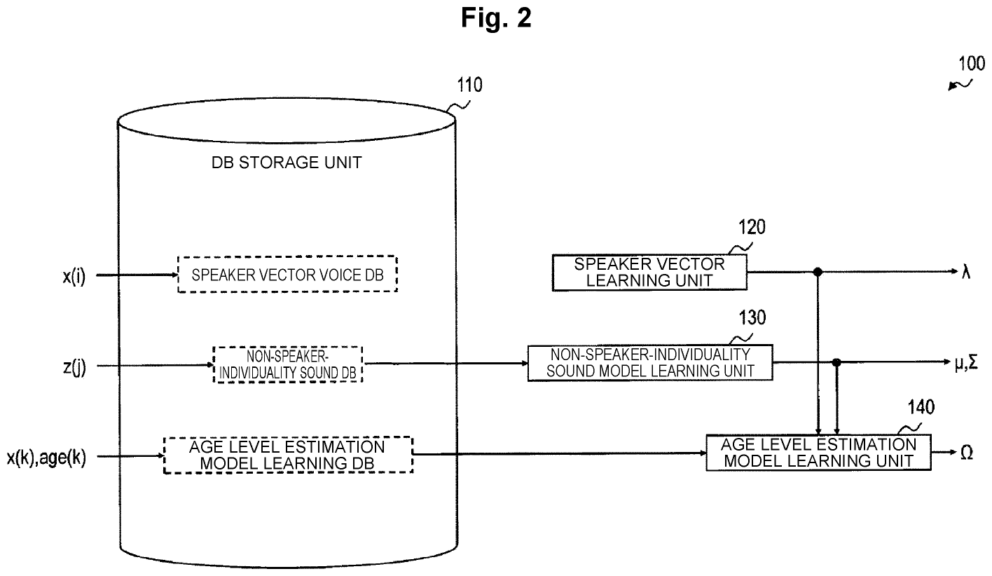

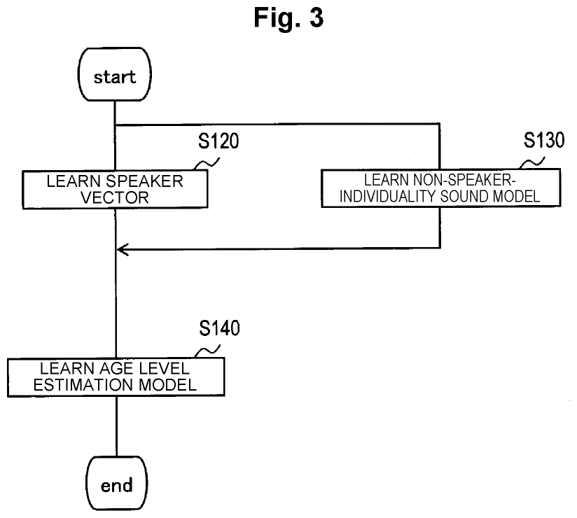

FIG. 2 shows a functional block diagram of the learning apparatus 100 and FIG. 3 shows a process flow of the learning apparatus 100.

The learning apparatus 100 includes a database storage unit 110, a speaker vector learning unit 120, a non-speaker-individuality sound model learning unit 130, and an age level estimation model learning unit 140.

The learning apparatus 100 accepts input of speech voice data x(i) and x(k) for learning and non-speaker-individuality sound data z(j) for learning and stores the data in the database storage unit 110 prior to learning. Using information from the database storage unit 110, the learning apparatus 100 learns a speaker vector extraction parameter λ, internal parameters μ and Σ of a probability distribution model, and a parameter Ω of an age level estimation model and outputs the learned parameters λ, μ, Σ, and Ω.

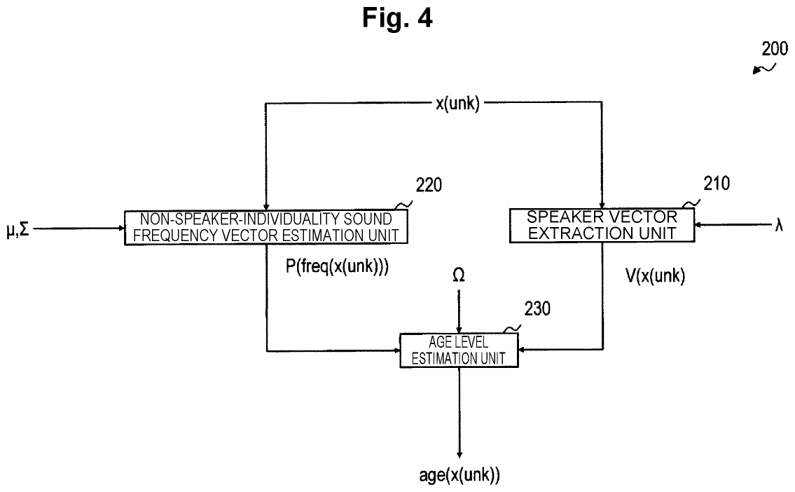

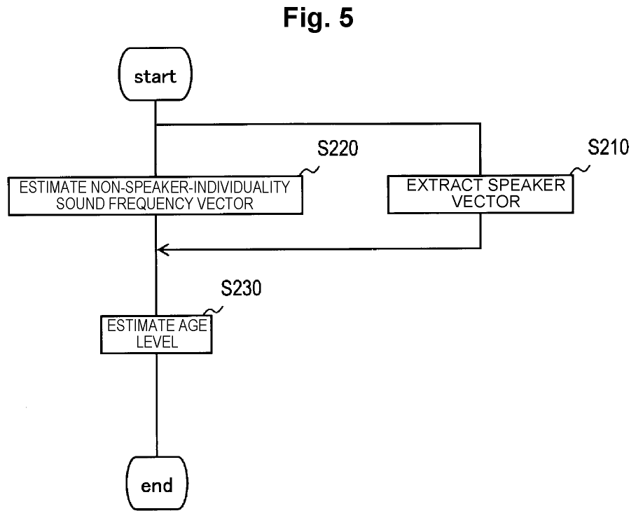

FIG. 4 shows a functional block diagram of the estimation apparatus 200 and FIG. 5 shows a process flow of the estimation apparatus 200.

The estimation apparatus 200 includes a speaker vector extraction unit 210, a non-speaker-individuality sound frequency vector estimation unit 220, and an age level estimation unit 230.

Prior to age level estimation, the estimation apparatus 200 receives the parameters λ, μ, Σ, and Ω learned in advance.

The estimation apparatus 200 accepts input of speech voice data x(unk) to be estimated, estimates the age level of the speaker of the speech voice data x(unk), and outputs an estimation result age(x(unk)).

The learning apparatus 100 and the estimation apparatus 200 are, for example, special apparatuses each made up of a known or special-purpose computer equipped with a central processing unit (CPU) or a main storage device (RAM: Random Access Memory) and loaded with a special program. The learning apparatus 100 and the estimation apparatus 200 execute respective processes, for example, under the control of the central processing unit. Data input to the learning apparatus 100 and the estimation apparatus 200 as well as data obtained by the respective processes are, for example, stored in the main storage, read into the central processing unit from the main storage device as required, and used for other processes. Processing units of the learning apparatus 100 and estimation apparatus 200 may be at least partly made up of hardware such as integrated circuits. Storage units of the learning apparatus 100 and estimation apparatus 200 can each be made up, for example, of a main storage device such as a Random Access Memory (RAM) or middleware such as a relational database or a key-value store. However, the storage units do not necessarily have to be provided in the learning apparatus 100 or the estimation apparatus 200. Each of the storage units may be provided externally to the learning apparatus 100 or the estimation apparatus 200 by being made up of an auxiliary storage device, which is made up of a hard disk, an optical disk, or a semiconductor memory element such as a flash memory.

First, processes of components of the learning apparatus 100 will be described.

### Database Storage Unit 110

The database storage unit 110 stores a speaker vector voice database containing the speech voice data x(i) for learning, a non-speaker-individuality sound database containing the non-speaker-individuality sound data z(j) for learning, and an age level estimation model learning database containing the speech voice data x(k) and speaker age data age(k) for learning. Hereinafter databases will be referred to as DBs.

### Speaker Vector Voice DB

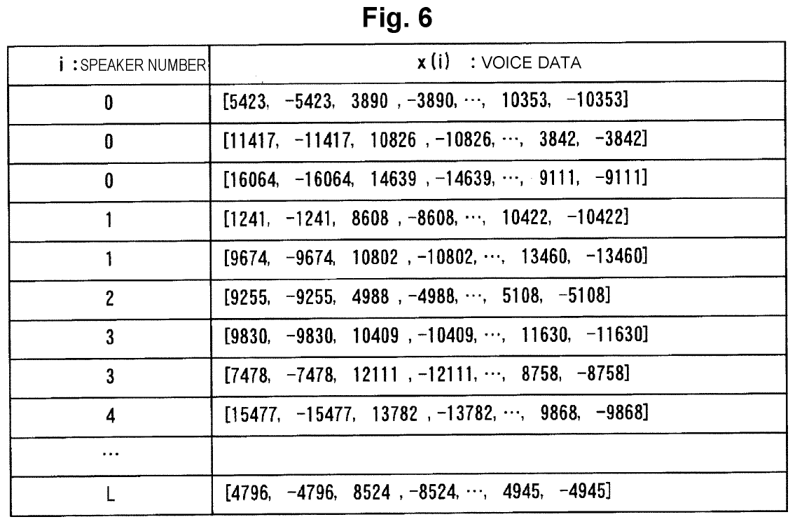

FIG. 6 shows an example of the speaker vector voice DB. The DB contains speaker numbers (i=0, 1, . . . , L) and corresponding speech voice data x(i) for learning. Because there can be plural speeches of one speaker, there are plural items of speech voice data associated with an identical speaker number in the DB. The bit rate of each item of voice data may be, for example, 8 kHz×16 bit×1 ch (monaural).

### Non-Speaker-Individuality Sound DB

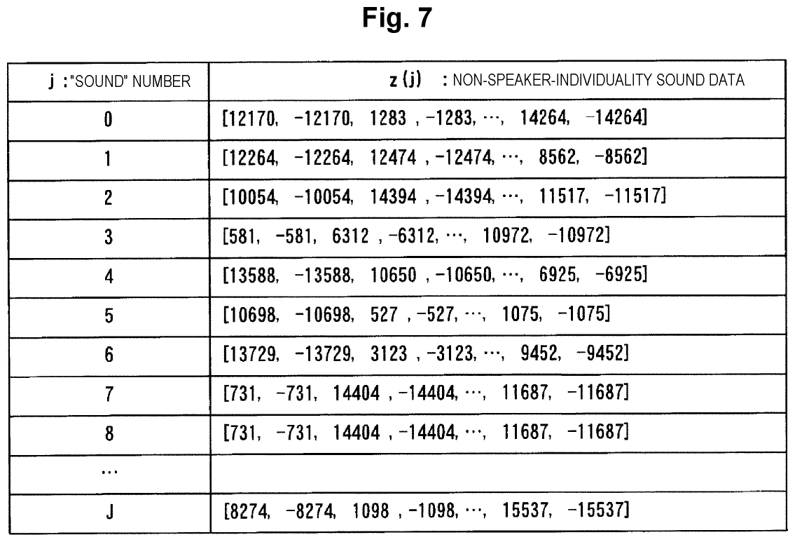

FIG. 7 shows an example of the non-speaker-individuality sound DB. The DB contains non-speaker-individuality sound numbers j (j=0, 1, . . . , J) and corresponding non-speaker-individuality sound data z(j) for learning. The voice data in the DB is the data obtained by cutting out only non-speaker-individuality sounds (e.g., water sounds liable to occur in elderly people) desired to be detected. For example, the bit rate of each item of non-speaker-individuality sound data is similar to the bit rate of data in the speaker vector voice DB.

### Age Level Estimation Model Learning DB

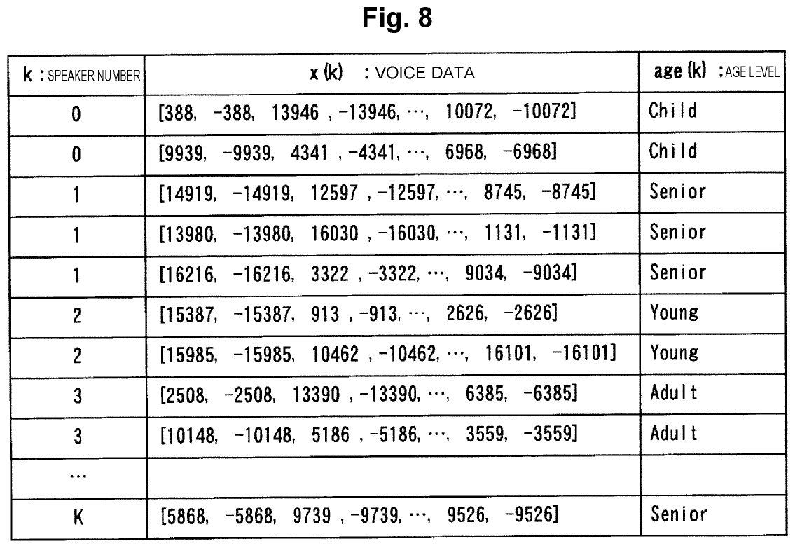

FIG. 8 shows an example of the age level estimation model learning DB. The DB contains speaker numbers k (k=0, 1, . . . , K) and corresponding speech voice data x(k) and speaker age data age(k) for learning. For example, the speaker age data age(k) contains any of speaker's age levels: Child, Young, Adult, and Senior.

Because there can be plural speeches of one speaker, there are plural items of speech voice data associated with an identical speaker number in the DB. For example, the bit rate of each item of voice data is similar to the bit rate of data in the speaker vector voice DB.

### Speaker Vector Learning Unit 120

The speaker vector learning unit 120 fetches all the learning speech voice data x(i) from the speaker vector voice DB, learns the speaker vector extraction parameter λ based on the fetched learning speech voice data x(i) (i=0, 1, . . . , L) (S120), and outputs the learned speaker vector extraction parameter λ.

For example, the speaker vector learning unit 120 calculates a feature value for use to find a speaker vector, from the learning speech voice data x(i) and learns the speaker vector extraction parameter λ using the feature value. Note that the speaker vector extraction parameter λ is a parameter used to extract the speaker vector from the feature value calculated from the speech voice data.

For example, as a feature value and extraction technique for extracting the speaker vector, known techniques are used. For example, an i-vector, an x-vector, or the like are used as the feature value.

### Non-Speaker-Individuality Sound Model Learning Unit 130

The non-speaker-individuality sound model learning unit 130 fetches all the non-speaker-individuality sound data z(j) from the non-speaker-individuality sound DB, creates a probability distribution model using frequency components of the fetched non-speaker-individuality sound data z(j), calculates internal parameters μ and Σ of the probability distribution model (S130), and outputs the internal parameters μ and Σ.

For example, first the non-speaker-individuality sound model learning unit 130 calculates the frequency components from the non-speaker-individuality sound data z(j). To calculate a spectrogram, the non-speaker-individuality sound model learning unit 130 applies, for example, band-pass filtering to each item of non-speaker-individuality sound data z(j) in a range of 200 Hz to 3.7 kHz, and then calculates the frequency components. For example, the frequency components are 512-dimensional and ranges from 200 Hz to 3.7 kHz. The non-speaker-individuality sound model learning unit 130 calculates frequency components freq(z(j))ₜ with a frame length of 10 ms and a shift width of 5 ms from the non-speaker-individuality sound data z(j), where t is a frame number.

Next, the non-speaker-individuality sound model learning unit 130 creates a probability distribution model using the frequency components freq(z(j))ₜ of all the frames calculated from respective items of the non-speaker-individuality sound data z(j). For example, if Gaussian Mixture Model (GMM) is used, parameters μ and Σ of a 512-dimensional probability distribution model capable of calculating non-speaker-individuality sound likelihood p(freq(z(j))ₜ) such as shown below are found.

$$p ( {freq ( z ( j ) )}_{t} ) = \frac{1}{\sqrt{2 π \vert \sum \vert}} exp ( {( {freq ( z ( j ) )}_{t} - μ )}^{T} {\sum }^{- 1} {( {freq ( z ( j ) )}_{t} - μ )}^{2} ) \qquad [ Math . 1 ]$$

The parameters μ and Σ can be found from all the frequency components freq(zⱼ)ₜ using the following expression.

$$μ = \frac{1}{N} {\sum }_{j} {\sum }_{t} {freq ( z ( j ) )}_{t} \qquad [ Math . 2 ]$$

$$\sum = \frac{1}{N} {\sum }_{j} {\sum }_{t} {( {freq ( z ( j ) )}_{t} - μ )}^{2} {( {freq ( z ( j ) )}_{t} - μ )}^{T}$$

N is the sum total of all the frames of the non-speaker-individuality sound data used for learning. Regarding the non-speaker-individuality sound data z(j), a concatenation of all the frames of non-speaker-individuality sound likelihood p(freq(z(j))ₜ) results in a non-speaker-individuality sound likelihood vector P(freq(z(j))).

### Age Level Estimation Model Learning Unit 140

The age level estimation model learning unit 140 fetches all the speech voice data x(k) for learning and speaker age data age(k) from the age level estimation model learning DB. Besides, the age level estimation model learning unit 140 receives the learned speaker vector extraction parameter λ and the internal parameters μ and Σ.

The age level estimation model learning unit 140 extracts speaker vectors V(x(k)) from the speech voice data x(k) for learning using the learned speaker vector extraction parameter λ.

The age level estimation model learning unit 140 calculates non-speaker-individuality sound likelihood vectors P(freq(x(k))) from the speech voice data x(k) for learning using the learned internal parameters μ and Σ.

Using the speaker vectors V(x(k)), the non-speaker-individuality sound likelihood vectors P(freq(x(k))), and the corresponding speaker age data age(k), the age level estimation model learning unit 140 learns the parameter Ω of the age level estimation model (S140), and outputs the learned parameter Ω. Note that the age level estimation model accepts input of a speaker vector and a non-speaker-individuality sound likelihood vector and outputs an estimated value of the age level of the corresponding speaker.

Learning of the age level estimation model uses machine learning based on neural networks, SVMs, or the like. As an input feature, a one-dimensional feature vector FEAT(x(k)) resulting from combining the speaker vector V(x(k)) and the non-speaker-individuality sound likelihood vector P(freq(x(k))) is used. Using the age level data age(k) of the speaker as data to be estimated (output value) regarding FEAT(x(k)), the age level estimation model learning unit 140 learns the parameter Ω of the age level estimation model and updates the parameter Ω repeatedly in such a way as to minimize estimation errors. For example, a classification problem of classifying speakers' age levels into four classes C[C₁=Child, C₂=Young, C₃=Adult, and C₄=Senior] is set up. As a classifier for use to deal with this problem, for example, a neural network that accepts input of the feature vectors FEAT(x(k)) and outputs posterior probabilities p(Cᵢ|age(k)) of the respective classes is suitable. When the model is a neural network, a typical neural-network learning method (error back-propagation method) is used to update weights.

Next, processes of components of the estimation apparatus 200 will be described using FIGS. 4 and 5.

### Speaker Vector Extraction Unit 210

Prior to an age level estimation process, the speaker vector extraction unit 210 receives a learned speaker vector extraction parameter λ.

The speaker vector extraction unit 210 accepts input of speech data x(unk) to be estimated, extracts a speaker vector V(x(unk)) from the speech data x(unk) by a technique similar to that of the age level estimation model learning unit 140 using the learned speaker vector extraction parameter λ (S210), and outputs the extracted speaker vector V(x(unk)). Note that x(unk) is data not used in the learning process and if the learning process is assumed to be a development process, the data x(unk) is the data given in an actual use scene.

### Non-Speaker-Individuality Sound Frequency Vector Estimation Unit 220

Prior to the age level estimation process, the non-speaker-individuality sound frequency vector estimation unit 220 receives the learned internal parameters μ and Σ.

The non-speaker-individuality sound frequency vector estimation unit 220 accepts input of speech data x(unk) to be estimated, calculates a non-speaker-individuality sound likelihood vector P(freq(x(unk))) from the speech data x(unk) to be estimated, using the internal parameters μ and Σ of the probability distribution model by a technique similar to that of the age level estimation model learning unit 140 (S220), and outputs the calculated non-speaker-individuality sound likelihood vector P(freq(x(unk))).

### Age Level Estimation Unit 230

The age level estimation unit 230 combines the speaker vector V(x(unk)) and the non-speaker-individuality sound likelihood vector P(freq(x(unk))) into a one-dimensional feature vector FEAT(x(unk)) and finds a posterior probability using a learned parameter Ω. For example, if a classification problem of classifying age levels into four classes is set up, the posterior probability is formulated as follows.

p(Cᵢ|age(x(unk)))=FEAT(x(unk))Ω [Math. 3]

Next, as indicated by the following expression, the age level estimation unit 230 finds a dimension that maximizes posterior probability p(C₁|age(x(unk))) and outputs an age level corresponding to the dimension as an estimation result age(x(unk)) (S230).

age(x(unk))=argmax(p(Cᵢ|age(x(unk)))) [Math. 4]

### Effect

The above configuration makes it possible to estimate speaker ages with higher accuracy than conventional age level estimation techniques that are based solely on speaker vectors.

### Other Variations

The present invention is not limited to the above embodiment and variation. For example, the various processes described above may be performed not only in time series in the order described above, but also in parallel or separately, as required or depending on the processing power of the apparatus that performs the processes. Besides, various changes may be made as required without departing from the gist of the present invention.

### Program and Recording Medium

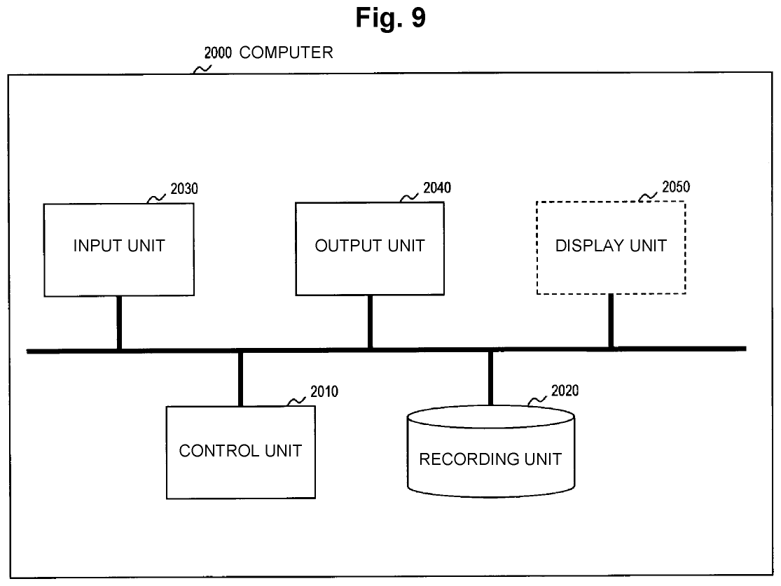

The various processes described above can be implemented by loading a program that executes the steps of the method described above into a recording unit 2020 of a computer shown in FIG. 9 and thereby causing a control unit 2010, an input unit 2030, and an output unit 2040 to operate.

The program describing process details can be recorded on a computer-readable recording medium. Examples of the computer-readable recording medium include a magnetic recording device, an optical disk, a magneto-optical recording medium, and a semiconductor memory.

The program can be distributed, for example, by selling, assigning, or lending a portable recording medium such as a DVD or a CD-ROM on which the program has been recorded. Furthermore, the program can be distributed by storing the program in a storage device of a server computer and transferring the program from the server computer to other computers through a network.

First, a computer that executes the program once stores the program in a storage device of the computer, for example, by acquiring the program recorded in a portable recording medium or transferred from a server computer. Then, in performing a process, the computer reads the program out of its own recording medium and performs the process according to the read program. As another execution mode of the program, the computer may read the program directly from a portable recording medium and perform a process according to the program, or each time a program is transferred to the computer from a server computer, the computer may perform a process sequentially according to the received program. Alternatively, the process may be performed by a so-called Application Service Provider (ASP) service whereby a server computer transfers no program to the computer and achieves processing functions solely via program execution instructions and result acquisition. Note that the programs according to the present mode include information equivalent to a program and used for processing by an electronic computer (e.g., data that is not provided as direct instructions to the computer, but that prescribes processing of the computer).

Although, according to the present mode, the present apparatus is implemented through execution of a predetermined program on a computer, at least part of the process details may be implemented in a hardware.

1. A learning apparatus comprising a processor configured to execute a method comprising:
learning a speaker vector extraction parameter λ based on one or more items of learning speech voice data in a speaker vector voice database;
creating a probability distribution model using a frequency component of one or more items of non-speaker-individuality sound data in a non-speaker-individuality sound database;
calculating an internal parameter of the probability distribution model;
extracting a speaker vector from voice data in an age level estimation model-learning voice database using the speaker vector extraction parameter λ, calculate a non-speaker-individuality sound likelihood vector from voice data in the age level estimation model-learning voice database using the internal parameters μ and Σ; and
learning, with input of a speaker vector and a non-speaker-individuality sound likelihood vector, a parameter Ω of an age level estimation model that outputs an estimated value of an age level of a corresponding speaker.

2. An estimation apparatus comprising a processor configured to execute a method comprising:
extracting a speaker vector V(x(unk)) from speech data to be estimated using a speaker vector extraction parameter λ;
calculating a non-speaker-individuality sound likelihood vector P(freq(x(unk))) from the speech data to be estimated, using internal parameters μ and Σ;
determining posterior probability from the speaker vector V(x(unk)) and the non-speaker-individuality sound likelihood vector P(freq(x(unk))) using a parameter Ω, wherein a combination of the speaker vector extraction parameter Ω, the internal parameters μ and Σ, and the parameter Ω, is based on a learnt age level estimation model;
determining a dimension that maximizes the posterior probability; and
using an age level corresponding to the dimension as an estimation result.

3. A computer implemented method for learning, comprising:
learning a speaker vector extraction parameter λ based on one or more items of learning speech voice data in a speaker vector voice database;
creating a probability distribution model using a frequency component of one or more items of non-speaker-individuality sound data in a non-speaker-individuality sound database;
calculating an internal parameter of the probability distribution model;
extracting a speaker vector from voice data in an age level estimation model-learning voice database using the speaker vector extraction parameter λ;
calculating a non-speaker-individuality sound likelihood vector from voice data in the age level estimation model-learning voice database using the internal parameters μ and Σ; and
learning, with input of a speaker vector and a non-speaker-individuality sound likelihood vector, a parameter Ω of an age level estimation model that outputs an estimated value of an age level of a corresponding speaker.

4. The computer implemented according to claim 3, further comprising:
extracting a speaker vector V(x(unk)) from speech data to be estimated using the speaker vector extraction parameter λ;
calculating a non-speaker-individuality sound likelihood vector P(freq(x(unk))) from the speech data to be estimated, using the internal parameters μ and Σ; and
determining posterior probability from the speaker vector V(x(unk)) and the non-speaker-individuality sound likelihood vector P(freq(x(unk))) using the parameter Ω;
determining a dimension that maximizes the posterior probability; and
using an age level corresponding to the dimension as an estimation result.

5. (canceled)

6. The learning apparatus according to claim 1, wherein the age level estimation model uses machine learning based at least on a neural network.

7. The learning apparatus according to claim 1, wherein the non-speaker-individuality sound data include data associated with a water sound produced in part based on an amount and viscosity of saliva in an oral cavity, an amount of saliva secretion, and a continuous speech duration.

8. The learning apparatus according to claim 1, wherein the age level estimation model estimates an age level of a speaker speaking a speech, and wherein the speech data includes data associated with the speech spoken by the speaker.

9. The estimation apparatus according to claim 2, wherein the age level estimation model uses machine learning based at least on a neural network.

10. The estimation apparatus according to claim 2, wherein the non-speaker-individuality sound data include data associated with a water sound produced in part based on an amount and viscosity of saliva in an oral cavity, an amount of saliva secretion, and a continuous speech duration.

11. The estimation apparatus according to claim 2, wherein the age level estimation model estimates an age level of a speaker speaking a speech, and wherein the speech data includes data associated with the speech spoken by the speaker.

12. The computer implemented method according to claim 3, wherein the age level estimation model uses machine learning based at least on a neural network.

13. The computer implemented method according to claim 3, wherein the non-speaker-individuality sound data include data associated with a water sound produced in part based on an amount and viscosity of saliva in an oral cavity, an amount of saliva secretion, and a continuous speech duration.

14. The computer implemented method according to claim 3, wherein the age level estimation model estimates an age level of a speaker speaking a speech, and wherein the speech data includes data associated with the speech spoken by the speaker.

15. The computer implemented method according to claim 4, wherein the age level estimation model uses machine learning based at least on a neural network.

16. The computer implemented method according to claim 4, wherein the non-speaker-individuality sound data include data associated with a water sound produced in part based on an amount and viscosity of saliva in an oral cavity, an amount of saliva secretion, and a continuous speech duration.

17. The computer implemented method according to claim 4, wherein the age level estimation model estimates an age level of a speaker speaking a speech, and wherein the speech data includes data associated with the speech spoken by the speaker.
